(19) United States
(12) Patent Application Publication
(10) Pub. No.: US 2007/0107479 A1
(43) Pub. Date: May 17, 2007

(54) Apparatus for securing a deadbolt

(75) Inventor: Philip H. Robertson, Texarkana, TX (US)

Correspondence Address: STEPHEN R. ROBINSON, 1121 PENNSYLVANIA, LAWRENCE, KS, 66044, US

(73) Assignee: Downing-Yee-Fulford, LLC

(21) Appl. No.: 11/199,713

(22) Filed: Aug. 9, 2005

(51) Int. Cl. E05B 13/00

(52) U.S. Cl. 70/416

(57) ABSTRACT

An apparatus for adaptive use with a single-cylinder deadbolt assembly prevents retraction of the extended deadbolt by a key, when the apparatus is in the engaged position. Thus the door will remain locked despite the attempted use of a key for the deadbolt on the outside of the door. The apparatus includes a cylindrical, hollow frame mounted on the security side of the door, the frame including an engaged-fixing site and a retracted-fixing site. A cylindrical security member is received within the frame, the security member having a thumb latch-engaging member including two tines formed on the operational end. A screw or other fixing member is removably received by both the frame and security member at one of the two sites. The security member may be positioned so that the thumb latch-engaging member is in an extended position relative to the thumb latch, and the screw is reversibly fixed in the engaged-fixing site so as to fix the security member and prevent axial shifting of the security member relative to the frame, causing the thumb latch-engaging member of the security member to restrict the thumb latch from operational rotation and therefore the deadbolt may not be retracted by means of a key.

### BACKGROUND OF THE INVENTION

1. Field of the Invention

The present invention relates generally to door security devices and more particularly to an apparatus for securing an extended deadbolt.

2. Background

Deadbolts have been used to secure doors for some time. They provide much greater protection than the sole reliance on the conventional latch bolt employed by almost every door. Once a deadbolt has been extended into the adjacent wall, the door becomes extremely difficult to open provided the deadbolt has been secured to the door and as long as the area of the wall receiving the extended deadbolt is sufficiently sturdy. Assuming both requirements are met, there are two remaining security issues on the outside of the door: 1) an unauthorized key capable of retracting the deadbolt from the outside; and 2) tools capable of “picking” a lock from the outside. Additionally, there are security issues from inside the door. Young children (e.g. at daycare or at home) may want to wander outside unsupervised and simply retract the deadbolt by turning the thumb latch and then simply open the door.

The reasons a key's use might be unauthorized are almost as diverse as human behavior. A landlord could change tenants but forget to collect the deadbolt key from the old tenant. A couple could have so recently become estranged that the remaining spouse simply didn't have time to change the locks. Keys are sometimes stolen and master keys may sometimes be used by professional criminals and others.

What is needed is an apparatus which will prevent the use of a key for retraction of an extended deadbolt. Further, it would be helpful if such an apparatus had low cost, and was portable for installation. Further, an apparatus is needed which makes it more difficult for an unauthorized person, such as a child, to retract the deadbolt from the inside by simply turning the thumb latch.

### SUMMARY OF THE INVENTION

The apparatus of the present invention solves the problems identified above (at least for a single-cylinder deadbolt assembly). It provides a solution for the problem of unauthorized use of a key or tools used to pick locks with low cost, portability and ease of installation.

The present invention provides an apparatus for mounting on a door or other structural substrate from the inside for adaptive use with a single-cylinder deadbolt assembly. The deadbolt assembly includes a deadbolt, a security faceplate and a thumb latch, with the security faceplate and thumb latch mounted on the security side of the door. The deadbolt assembly is designed for operational rotation of the thumb latch on the security side of the door or use of a key on the key side of the door, causing the deadbolt reversibly to extend or retract from the door and engage or disengage, respectively, a wall or other structure adjacent the door, so that the door cannot be opened without exceptional force when the deadbolt is extended into the wall.

The apparatus includes a frame mounted on the security side of the door, including an engaged-fixing site and a retracted-fixing site. A security member is operatively associated with the frame, having a thumb latch-engaging member formed on a first end, and a second end formed distal the first end, the first end and second end defining an axial length of the security member. A fixing member, such as a screw, is operatively associated with the frame and security member.

When the security member has been positioned so that the thumb latch-engaging member is in a retracted position relative to the thumb latch, and the fixing member is fixed in the retracted-fixing site, it prevents axial shifting of the security member relative to the frame. The security member is thus positioned not to restrict the thumb latch from operational rotation and therefore the deadbolt may be reversibly extended or retracted by means of a key from the key side.

But when the deadbolt has been placed in the extended position and the thumb latch has consequently been operationally rotated to its corresponding position the apparatus may then be operationally engaged. To do so, the security member is positioned so that the thumb latch-engaging member is in an extended position relative to the thumb latch, and the fixing member is reversibly fixed in the engaged-fixing site so as to fix the security member and prevent axial shifting of the security member relative to the frame. In this fashion the thumb latch-engaging member of the security member restricts the thumb latch from operational rotation. Therefore the deadbolt may not be retracted by means of a key or any other tools used to pick locks from the key side of the door. However, the security member is also easily retractable in order to allow for the quick operation of the thumb latch.

### BRIEF DESCRIPTION OF THE DRAWINGS

FIG. 1a is an isometric view of the inventive apparatus shown mounted on the interior side of a door engaged with a thumb latch;

FIG. 1b is an isometric view of the exterior side of the door;

FIG. 2 is the front view of Fig. 1a with the apparatus shown in retracted mode;

FIG. 3a is a perspective view of the frame;

FIG. 3b illustrates the mounting side of the frame;

FIG. 4 is an exploded perspective view of the security member and screw;

FIG. 5 is a side view of a security member included in the apparatus;

FIG. 6 is another side view of the security member illustrating the shape of the thumb latch-engaging member thereof;

FIG. 7 is an end view of the security member;

FIG. 8 is a side view of a frame included in the apparatus, illustrating a channel formed therein; and

FIG. 9 is an end view of the frame.

### DETAILED DESCRIPTION OF THE INVENTION

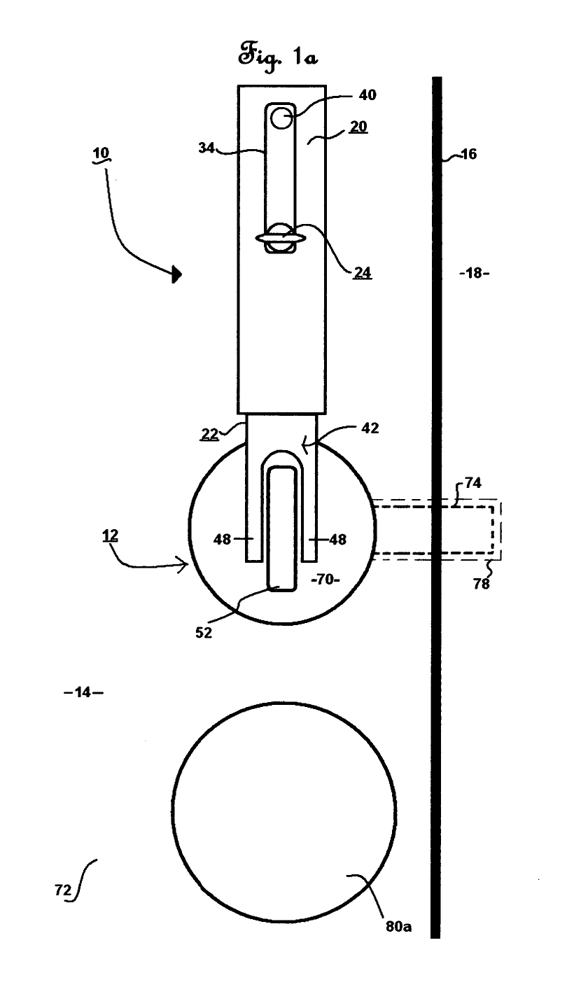

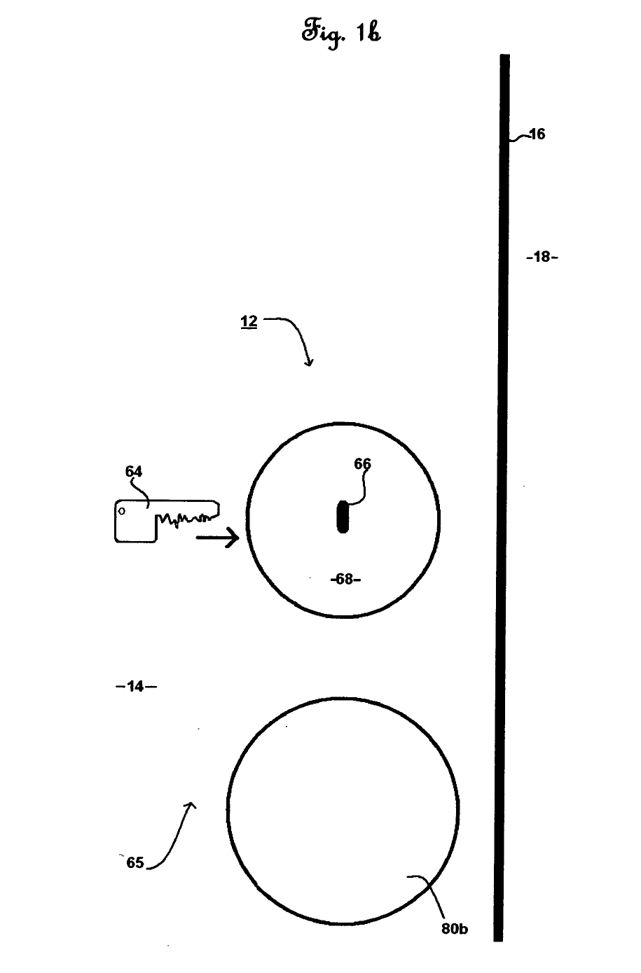

Referring now to the figures in general and Fig. 1a in particular, an apparatus 10 (also known commercially as the Lock Jaw™), is shown in operative association with a deadbolt assembly 12 (partially shown), a door 14 (or other substructural substrate), a doorjamb 16, adjacent wall or similar structure 18. Apparatus 10 includes a frame 20 a security 22 and a fixing member or screw 24. The apparatus 10 is shown in extended mode while in FIG. 2 apparatus 10 is shown in a retracted mode, both of which will be discussed in detail below.

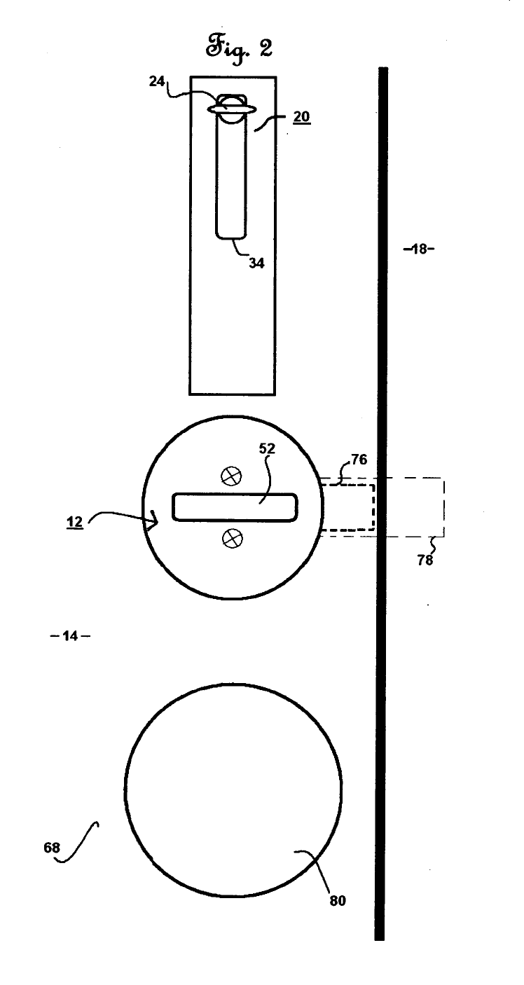

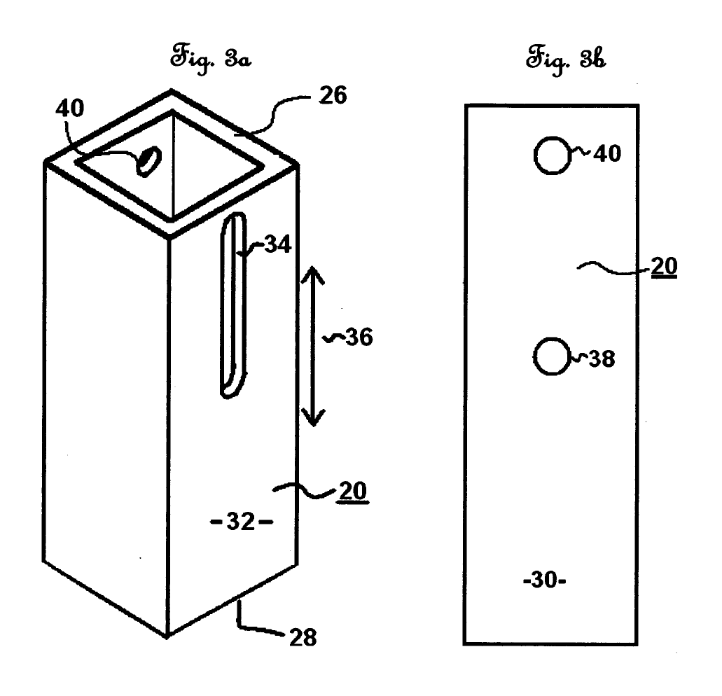

Referring to FIG. 3a frame 20 (of apparatus 10) is shown in perspective to be hollow and cylindrical in shape. Frame 20 presents a top end 26 at one end of frame 20 and a bottom 28 at the other end thereof Frame 20 also has a mounting side 30 (see FIG. 3b), and an opposite facing distal side 32. Distal side 32 includes portions forming a channel 34 which begins proximal to top 26 and ending about half way down distal side 32. The cylindrical shape of frame 20 presents an axial direction as indicated at reference numeral 36.

Referring to FIG. 3b, mounting side 30 includes an engaged-site hole 38 and a retracted-site hole 40.

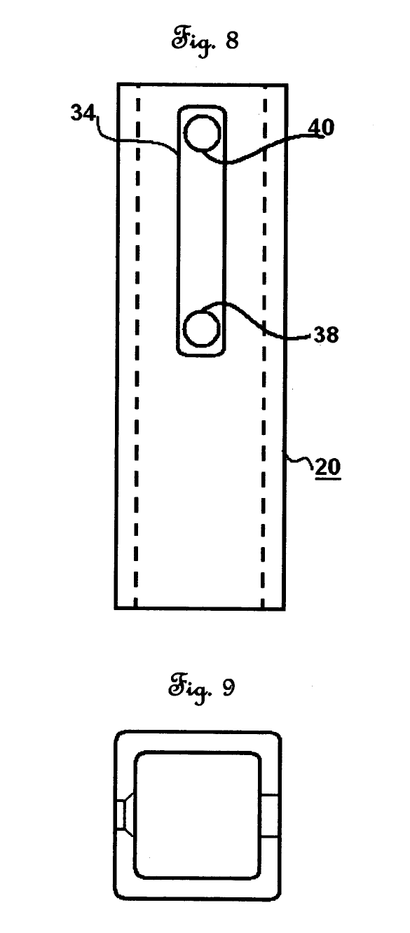

Engaged-site hole 38 along with the lower most portion of channel 34 (see FIG. 3a) together make up an engaged-fixing site. Analogously, retracted-site hole 40 and upper most portions of channel 34 together form retracted-fixing site. Note that the retracted-site hole 40 is in substantial alignment with the top of channel 34 and that the engaged-site hole 38 is substantial alignment with the bottom of channel 34 (see FIG. 8).

Referring to FIG. 4, security member 22 is shown in perspective with fixing member 24. Security member 22 is received within the hollow volume of frame 20 to allow axial shifting of security member 22. Security member 22 has a thumb latch-engaging member 42 formed on a first end 44 thereof and a second end 46 formed distal from first end 44. First end 44 and second end 46 define the same axial length 36 as noted in FIG. 3a. Thumb-latch-engaging member 42 includes two flat wide tines 48 downwardly extending in axial direction 36. Tines 48 form an arcuate invagination 50 (see also FIG. 6) adapted for engagement with a thumb latch 52 (see FIG. 1a).

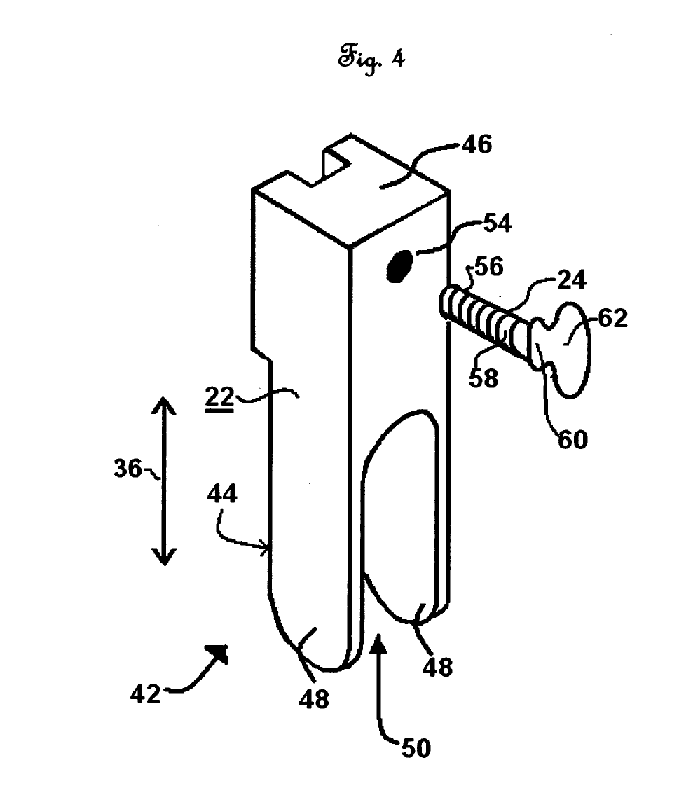

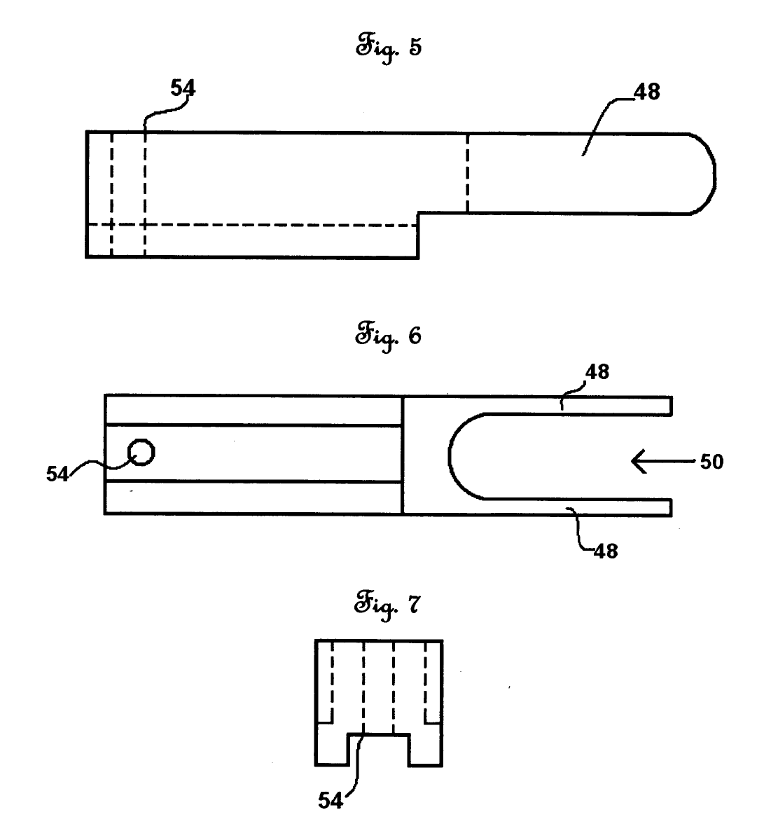

Security member 22 also includes portions forming a threaded bore 54 (see also FIGS. 5 and 6) which alternatively forms a portion of both the engaged-fixing site and the retracted-fixing site in a fashion to be explained below.

Still referring to FIG. 4, fixing member 24 is a threaded screw including a threaded portion 56 for mating engagement with threaded bore 54. Screw 24 also includes a shaft 58, a flange 60 and a head 62. In this fashion fixing member 24 maybe reversibly removed from threaded bore 54, although it will readily be appreciated that the other means of fixing security member 22 relative to frame 20 to prevent axial shifting along axis 36 maybe utilized, such as a cotter pin or the like.

Referring to FIG. 1b, deadbolt assembly 12 (partially shown) is a single-cylinder deadbolt device. In other words, a key 64 may only be used on the outside or key side 65 of door 14 at a keyhole 66 disposed in an outside faceplate 68.

With reference to Figs. 1a and 1b, assembly 12 is installed on door 14 with outside security faceplate 66 (see FIG. 1b), as well as thumb latch 52 and an inside security faceplate 70 on an interior or security side 72 of door 14 (FIG. 1a). In other words, the security side 72 of door 14 would normally be thought of as located in the interior of a room or a house or the like, while key side 72 of door 14 (FIG. 1b) would normally be exterior or even outdoors. In summary, deadbolt assembly 12 includes outside faceplate 66 on key side 77 of door 14, as well as keyhole 68 for use in retracting or extending a deadbolt 74 which is shown in phantom in the extended mode in FIG. 1a, while also shown in retracted mode in FIG. 2. Deadbolt 74, as is well-known in the art, lends security to door 14 by its extension into mortise 76 formed within portions of door 14, doorjamb 16 and wall 18 (FIG. 1a).

Door 14 (or substructural substrate, a gate, window or other portal) includes security side 72 and key side 65 as previously mentioned. Door 14 also includes knob 80a on the security side 72 (FIG. 1a) and another knob 80b on the key side 65 (FIG. 1b). Door jamb 16 is conventionally installed and well-known in the art. Installment of apparatus 10 will now be discussed.

Referring to FIG. 1a for installation of apparatus 10, first deadbolt assembly 12 is previously installed to be capable of both the extended mode shown in FIG. 1a and the retracted mode shown in FIG. 2. In other words, deadbolt 74 is capable of being extended for security purposes or it can also be retracted so that door 14 can be simply opened with door knob 80a or 80b, respectively from either the inside or the outside (assuming any locking mechanism for knobs 80a and 80b have not otherwise been engaged). Next, deadbolt assembly 12 is placed in extended mode as illustrated in FIG. 1a.

For the next step of installation, apparatus 10 must be lined up in orientation to thumb latch 52. Obviously if door knob 80a is located above faceplate 70 rather than below it, as shown in FIG. 1a, then the vertical orientation of apparatus 10 would be beneath thumb latch 52 rather than as shown.

Once frame 20 of apparatus 10 has been vertically aligned with thumb latch 52 it must then be checked for positioning in both the extended-security-member mode and retracted-security-member mode of apparatus 10. In other words, apparatus 10 is shown in FIG. 1a in extended-security-member mode (with security member 22 extended) while apparatus 10 is in retracted-security-member mode (with security member 22 positioned inside frame 20) in FIG. 2. So the final positioning prior to installment is determined by viewing the vertical extension of security member 22 relative to thumb latch 52. Once frame 20 position has been determined, apparatus 10 can be affixed to door 14 by glue, adhesive strip or the like applied to mounting side 30 of the frame 20 (see FIG. 3b). Screws or nails could also be used if apparatus 10 were provided with holes in frame 20 or with some kind of mounting plate affixed to frame 20. But in the preferred embodiment, no such holes are provided because it is assumed it will be more convenient for the user to install by use of adhesive strips, glue or the like.

After installment apparatus 10 can easily be de-installed. For example, if glue were to be used a solvent or a heating of the glued surface can be used to remove apparatus 10. Likewise an adhesive strip might simply be removed by mechanical pressure. The convenience of mounting apparatus 10 is enhanced by the fact that very little mechanical stress will be applied to apparatus 10 in the course of its operation as will be discussed below. In this fashion, apparatus 10 can be taken by a person on a car trip and then easily installed at each hotel room in which the traveler stays and then de-installed when the traveler is checking out of the hotel. The inventive apparatus 10 may thus be used and reused at various locations which is facilitated by the easy portability and light weight.

In operation and referring to FIG. .2, the apparatus 10 is first placed in retracted-security-member mode, i.e. security member 22 is shifted so that it is received completely within frame 20. This is done by placing fixing member 24 through the uppermost portion of channel 34 and threading it into bore 54 (FIG. 4) and finally fixing the threaded end 56 (FIG. 4) of fixing member 24 into hole 40 (FIG. 3a). In this fashion, security member 22 is prevented from shifting along axis 36 in a vertical fashion. This constitutes the retracted-security-member mode. Note that the top 46 (FIG. 4) of security member 22 is flush with top 26 (FIG. 3a) of frame 20 in the retracted-security-member mode. In this retracted mode, it will be noted that thumb latch 52 of deadbolt assembly 12 is freely rotated to be placed in retracted deadbolt mode as illustrated in FIG. 2 or could also be placed in extended mode as shown in FIG. 1a where deadbolt 74 extends beyond door jamb 16 into mortise 78 formed within wall 18. Since thumb latch 52 is mechanically free to rotate from the horizontal position of the retracted-deadbolt mode to a vertical position of the extended-deadbolt mode, it can be manipulated by either manual adjustment from security side 72 (i.e. inside the room in question) or by manipulation of key 64 on key side 65 (i.e. outside the room in question).

The next step in operation is that deadbolt 74 is placed in extended-deadbolt mode by turning thumb latch 52 to the upright, vertical position as shown in FIG. 1a. Next security member 22 must be downwardly extended in the following fashion to achieve the extended-security-member mode. First, fixing member 24 must be loosened and removed at least from retracted fixing hole 40 which enables the downward movement of security member 22 relative to frame 20. In this fashion security member 22 is then downwardly shifted to the position indicated in FIG. 1a. Next, fixing member 24 is then rescrewed so that it engages extended-fixing site hole 38 (FIG. 3b). In this fashion the extended-security-member mode is achieved and thus thumb latch engaging member 42 of security member 22 restricts thumb latch 52 since tines 48 prevent any significant rotation of thumb latch 52.

Referring to FIG. 1b, it will be readily appreciated that use of key 64, when placed in keyhole 66 on key side 65 of door 14, simply will not be able to generate sufficient torque to overcome the restrictive engagement of tines 48 so that thumb latch 52 cannot be turned from key side 65. In this fashion it will be appreciated that not much mechanical mounting force between apparatus 10 and door 14 will be required to adequately withstand any torque that is physically possible to be exerted by key 64. Hence when apparatus 10 is in extended-security-member mode as illustrated in FIG. 1a, it prevents thumb latch 52 from any operational rotation, key 64 may not be used to retract bolt 74 and therefore anyone trying to enter through door 14 from the outside will not be able to, so long as apparatus 10 remains in extended-security-member mode without exertion of exceptional force.

It should be apparent that the invention not only accomplishes the major functions required from such apparatus 10, but does so in a particularly advantageous manner. It should be equally apparent, however, that various minor and equivalent modifications from the embodiments disclosed herein for illustrative purposes could be employed without departing from the essence of the invention. It is to be understood, therefore, that the invention should be regarded as encompassing not only the subject matter literally defined by the claims which follow, but also technical equivalents thereof

What is claimed is:

1. An apparatus for mounting on a structural substrate for adaptive use with a single-cylinder deadbolt assembly, the structural substrate presenting a key side and a security side, the deadbolt assembly including a deadbolt, a security faceplate and a thumb latch, with the security faceplate and thumb latch mounted on the security side of the structural substrate, the deadbolt assembly designed for operational rotation of the thumb latch on the security side of the door or use of a key on the key side of the door, causing the deadbolt reversibly to extend or retract from the structural substrate and engage or disengage, respectively, a wall or other structure adjacent the structural substrate, so that the structural substrate cannot be opened without exceptional force when the deadbolt is extended, the apparatus comprising:
(a) a frame mounted on the security side of the structural substrate, the frame including portions forming an engaged-fixing site and other portions forming a retracted-fixing site;
(b) a security member operatively associated with the frame, the security member having a thumb latch-engaging member formed on a first end thereof, and a second end formed distal the first end, the first end and second end defining an axial length of the security member; and
(c) a fixing member operatively associated with the frame and security member,
wherein when the security member has been axially shifted relative to the frame so that the thumb latch-engaging member is in a retracted position relative to the thumb latch, and the fixing member is reversibly fixed in the retracted-fixing site so as to fix the security member and prevent axial shifting of the security member relative to the frame, with the security member consequently positioned not to restrict the thumb latch from operational rotation and therefore the deadbolt may be reversibly extended or retracted by means of a key from the key side,
and further wherein when the deadbolt has been placed in the extended position and the thumb latch has consequently been operationally rotated to its corresponding position, and the security member has been axially shifted relative to the frame so that the thumb latch-engaging member is in an extended position relative to the thumb latch and the fixing member is reversibly fixed in the engaged-fixing site so as to fix the security member and prevent axial shifting of the security member relative to the frame, causing the thumb latch-engaging member of the security member to restrict the thumb latch from operational rotation and therefore the deadbolt may not be retracted by means of a key.

2. The apparatus of claim 1 wherein the fixing member is a threaded screw, including a head and flange at one end.

3. The apparatus of claim 2 wherein the thumb latch-engaging member includes two flat, wide tines downwardly extending in the axial direction, the tines forming an arcuate invagination adapted for engagement with the thumb latch.

4. The apparatus of claim 3 wherein the frame is hollow and cylindrical and the security member is also cylindrical for mating reception and axial adjustment within the frame.

5. The apparatus of claim 4 wherein the frame presents a top at one end of the cylinder, a bottom at the other end thereof, a mounting side and an opposite facing distal side with the engaged-fixing site and the retracted-fixing site including portions forming an axially extending channel on the distal side, the channel beginning proximal the top of the frame and ending about halfway down the distal side.

6. The apparatus of claim 5 wherein the engaged-fixing site and the retracted-fixing site further include respectively portions forming an engaged-site hole and portions forming a retracted-site hole, the engaged-site hole formed in the mounting side of the frame in substantial alignment with the end of the channel, with the retracted-site hole formed in the mounting side in substantial alignment with the top of the channel.

7. The apparatus of claim 6 wherein the security member includes portions forming a threaded bore for mating, reversible reception of the screw, such that when the threaded end of the screw is placed though the channel and threaded into the bore and then secured in the retracted-site hole, the top of the security member is flush with the top of the frame.

8. An apparatus for mounting on a door for adaptive use with a single-cylinder deadbolt assembly, the door presenting a key side and a security side, the deadbolt assembly including a deadbolt, a security faceplate and a thumb latch, with the security faceplate and thumb latch mounted on the security side of the door, the deadbolt assembly designed for operational rotation of the thumb latch on the security side of the door or use of a key on the key side of the door, causing the deadbolt reversibly to extend or retract from the door and engage or disengage, respectively, a wall adjacent the door, so that the door cannot be opened without exceptional force when the deadbolt is extended, the apparatus comprising:
(a) a cylindrical, hollow frame mounted on the security side of the door, the frame including portions forming an engaged-fixing site and other portions forming a retracted-fixing site;
(b) a security member operatively associated with the frame, the security member having a thumb latch-engaging member including two tines formed on a first end thereof, and a second end formed distal the first end, the first end and second end defining an axial length of the security member; and
(c) a threaded screw operatively associated with the frame and security member,
wherein when the security member has been axially shifted relative to the frame so that the thumb latch-engaging member is in a retracted position relative to the thumb latch, and the screw is reversibly fixed in the retracted-fixing site so as to fix the security member and prevent axial shifting of the security member relative to the frame, with the security member consequently positioned not to restrict the thumb latch from operational rotation and therefore the deadbolt may be reversibly extended or retracted by means of a key from the key side,
and further wherein when the deadbolt has been placed in the extended position and the thumb latch has consequently been operationally rotated to its corresponding position, and the security member has been axially shifted relative to the frame so that the thumb latch-engaging member is in an extended position relative to the thumb latch, and the screw is reversibly fixed in the engaged-fixing site so as to fix the security member and prevent axial shifting of the security member relative to the frame, causing the thumb latch-engaging member of the security member to restrict the thumb latch from operational rotation and therefore the deadbolt may not be retracted by means of a key.

9. The apparatus of claim 8 wherein the threaded screw includes a head and flange at one end.

10. A system for adaptive use with a structural substrate and an adjoining wall or other structure, the structural substrate presenting a key side and a security side, the system comprising:
(a) a single-cylinder deadbolt assembly, the deadbolt assembly including a deadbolt, a security faceplate and a thumb latch, with the faceplate and thumb latch mounted on the security side of the structural substrate, the deadbolt assembly designed for operational rotation of the thumb latch on the security side of the door or use of a key on the key side of the door, causing the deadbolt to extend from the structural substrate and engage the wall adjacent the structural substrate, so that the structural substrate cannot be opened without exceptional force;
(b) a frame mounted on the security side of the structural substrate, the frame including portions forming an engaged-fixing site and other portions forming a retracted-fixing site;
(c) a security member operatively associated with the frame, the security member having a thumb latch-engaging member formed on a first end thereof, and a second end formed distal the first end, the first end and second end defining an axial length of the security member; and
(d) a fixing member operatively associated with the frame and security member,
wherein when the security member has been axially shifted relative to the frame so that the thumb latch-engaging member is in a retracted position relative to the thumb latch and the fixing member is reversibly fixed in the retracted-fixing site so as to fix the security member and prevent axial shifting of the security member relative to the frame, the security member does not restrict the thumb latch from operational rotation and therefore the deadbolt may be reversibly extended or retracted by means of a key from the key side,
and further wherein when the deadbolt has been placed in the extended position and the thumb latch has consequently been operationally rotated to its corresponding position, and the security member has been axially shifted relative to the frame so that the thumb latch-engaging member is in an extended position relative to the thumb latch and the fixing member is reversibly fixed in the engaged-fixing site so as to fix the security member and prevent axial shifting of the security member relative to the frame, the thumb latch-engaging member of the security member restricts the thumb latch from operational rotation and therefore the deadbolt may not be retracted by means of a key from the key side.

11. The apparatus of claim 1 wherein the fixing member is a threaded screw, including a head and flange at one end.
